(19) United States
(12) Patent Application Publication
(10) Pub. No.: US 2015/0081129 A1
(43) Pub. Date: Mar. 19, 2015

(54) EQUIPMENT OVERLOAD SUCCESSIVE APPROXIMATION ADAPTIVE CONTROL METHOD BASED ON CENTRALIZED REAL-TIME DECISION

(71) Applicants: STATE GRID ELECTRIC POWER INSTITUTE, NANJING (CN); NANJING NANRUI GROUP, NANJING (CN); SHANGHAI MUNICIPAL ELECTRIC POWER COMPANY, Shanghai (CN)

(72) Inventors: Taishan Xu, Jiangsu (CN); Chuanpu Xu, Jiangsu (CN); Bijun Li, Jiangsu (CN); Wei Wang, Jiangsu (CN); Yanhong Bao, Jiangsu (CN); Jun Mao, Jiangsu (CN); Chuanzhi Xie, Jiangsu (CN); Minjie Jin, Jiangsu (CN); Maxiang Wang, Jiangsu (CN)

(21) Appl. No.: 14/365,661

(22) PCT Filed: Sep. 27, 2012
(86) PCT No.: PCT/CN2012/082158

§ 371 Date: Oct. 17, 2014

(30) Foreign Application Priority Data
Dec. 28, 2011 (CN) 201110445359.6

(51) Int. Cl. G05F 1/66; G05B 15/02

(52) U.S. Cl. CPC G05F 1/66; G05B 15/02
USPC 700/297

(57) ABSTRACT

An equipment overload successive approximation adaptive control method based on centralized real-time decisions is provided. The method estimates in real time permissible current for long-term running of equipment and continuous running time according to current and temperature actual measurement information of the equipment. Control modes are decided according to the continuous running time of the equipment instead of current. On the basis of mixed integer nonlinear programming algorithm, a target function which aims to control the total cost and minimize comprehensive indexes of proportions of load control quantities of different regions is adopted, discreteness and cost of a control measure are taken into consideration, flow restraint of an electric system is measured, a centralized optimization decision and successive approximation control strategy are adopted, coordination to real-time scheduling operation control and emergency control for overload of equipment of the electric system is realized.

### CROSS-REFERENCE TO RELATED APPLICATIONS

This application claims priority to PCT Application No. PCT/CN2012/082158, having a filing date of Sep. 27, 2012, based off of CN Application No. 201110445359.6, having a filing date of Dec. 28, 2011, the entire contents of which are hereby incorporated by reference.

### FIELD OF TECHNOLOGY

The following relates to the technical field of electric power systems control. It is applicable to establishment and implementation of adaptive control strategy in case of equipment overload in electric power systems.

### BACKGROUND

With enhanced grid structure and increase of grid transmission capacity, equipment overload has gradually become a main issue that constraints safe, reliable, and economic operation of grid. In the stage of fast grid development, complicated grid frame structure, and varying operation modes, for equipment (line, transformer) overload, it is still difficult to use offline analysis to establish reasonable control strategy. To solve the problems of insufficient dispatching operation control execution time and control quantity, over high control cost, over centralized load control measures, etc. it is urgent to study equipment overload adaptive control method based on centralized real-time decision-making.

Patent “Centralized decision-making and real-time emergency control method for eliminating overload in large power grid” (ZL200710135096.2) proposes the following method: according to information measured by security control device (SCD), obtain grid operation state data through adjustment of EMS state estimation data, and based on this, according to sensitivity of eliminating equipment overload by candidate control measures (generator and load etc.), taking into consideration cost of control measures and extent of equipment overload, calculate comprehensive indexes of control measures; next, according to sequence of absolute values of comprehensive indexes, select generator units of positive index and load nodes of negative index for participation in emergency control, and bisection method is used to calculate optimized emergency control scheme. This method can quickly calculate control strategy, but the search strategy of control measures according to sequence of comprehensive indexes cannot ensure optimization, and does not involve judgment of equipment actual overload extent and permissible continuous operation time, nor coordination between emergency control and dispatching operation control.

Different from prior art, the present invention discloses the method of real-time estimation of equipment long-term allowable current and continuous operation time according to measured current and temperature information, and determination of control modes according to continuous operation time of equipment instead of the long-term allowable current. The decision optimization models of dispatching operation control and SCD emergency control aimed to minimize control costs have been established, taking into consideration discrete and decentralized requirements on load control. The control strategy of successive approximation according to equipment state is adopted, introducing mixed integer nonlinear programming algorithm, thus solving the problems of insufficient dispatching operation control execution time and control quantity, over high control cost, over centralized load control measures, etc. while realizing comprehensive application of and coordination between emergency control measures and dispatching operation control measures for eliminating equipment overload.

### SUMMARY

The purpose of the present invention is to propose an equipment overload adaptive emergency control method based on centralized real-time decision-making, that can automatically judge equipment overload state according to present and history operation state of the equipment, comprehensively apply emergency control and dispatching operation control means to eliminate equipment overload, and solve the problems of insufficient dispatching operation control execution time and control quantity, over high control cost, over centralized load control measures, etc., and ensure reliability and optimization of equipment overload control.

The present invention is realized by the following technical scheme, comprising the following steps:

1) Based on equipment current acquired in real-time by security control device (SCD), and temperature information acquired in real-time by equipment temperature monitoring device, estimate in real-time long-term allowable current and continuous operation time of the equipment under present operating environment;

2) If minimum value of continuous operation time of all equipment is greater than the set dispatching operation control time limit, neither control strategy calculation nor control of the electric system will be performed. If this minimum value is less than or equal to the dispatching operation control time limit but greater than the emergency control time limit, go to step 3) for optimal dispatching operation control strategy calculation and implementation. If this minimum value is less than or equal to the emergency control time limit, go to step 4) for optimal emergency control strategy calculation and implementation;

3) First, based on grid beyond the dispatching management (abbreviated as External Network) state estimation data or typical operation mode data, carry out static equivalence of the External Network according to the criterion that electric distance between External Network side buses of tie-line between External Network and Internal Network (grid under dispatching management) shall exceed the set value. Next, based on Internal Network state estimation data and External Network equivalence data, carry out the operation profile data integration according to real-time power flow data of equipment of continuous operation time less than or equal to dispatching operation control time limit (such equipment is referred to as overload equipment in alarm state) and power flow data acquired in real-time by SCD. Later, for the grid after equivalence, using the objective function aimed to minimize total control cost and comprehensive indexes of proportions of load control quantity in different regions, taking into consideration discreteness and cost of dispatching operation control measures, and under the restraint of electric system power flow, and based on mixed integer nonlinear programming algorithm, centralized decision-making optimization and successive approximation control strategy are adopted for calculation of real-time optimal dispatching operation control strategy for equipment overload in alarm state, which will be implemented by dispatching operator; after implementation of control measures, return to step 1);

4) First, based on External Network state estimation data or typical operation mode data, carry out static equivalence of the External Network according to the criterion that electric distance between External Network side buses of tie-line between External Network and Internal Network (grid under dispatching management) shall exceed the set value. Next, based on Internal Network state estimation data and External Network equivalence data, carry out the operation profile data integration according to real-time power flow data of equipment of continuous operation time less than or equal to emergency control time limit (such equipment is referred to as overload equipment in emergent state) and power flow data acquired in real-time by SCD. Later, for the grid after equivalence, using the objective function aimed to minimize total control cost and comprehensive indexes of proportions of load control quantity in different regions, taking into consideration discreteness and cost of emergency control measures, and under the restraint of electric system power flow, and based on mixed integer nonlinear programming algorithm, centralized decision-making optimization and successive approximation control strategy are adopted for calculation of real-time optimal emergency control strategy for equipment overload in emergent state, which will be implemented by SCD; after implementation of control measures, return to step 1).

### Effect and Advantages

Since equipment long-term allowable current and continuous operation time under certain set current condition are related to equipment operating environment (e.g. ambient temperature, sunshine, and wind velocity etc.), the present invention has solved the problem by real-time estimation of equipment long-term allowable current and continuous operation time according to present measured information and history current and temperature information. In prior art, equipment overload control mode is determined according to equipment current exceeding different preset values. As a contrast, the present invention decides control mode according to equipment continuous operation time instead of current, thus meeting actual requirements on selection of control mode. The present invention has established decision-making optimization models of dispatching operation control and SCD emergency control aimed to minimize control costs respectively, taking into consideration discrete and decentralized requirements on load control, adopting successive approximation control strategy according to equipment state, and introducing mixed integer nonlinear programming algorithm, thus solving the problems of insufficient dispatching operation control execution time and control quantity, over high control cost, over centralized load control measures, etc. while realizing comprehensive application of and coordination between emergency control and dispatching operation control means that eliminate equipment overload, to ensure reliable and optimized equipment overload control.

### BRIEF DESCRIPTION

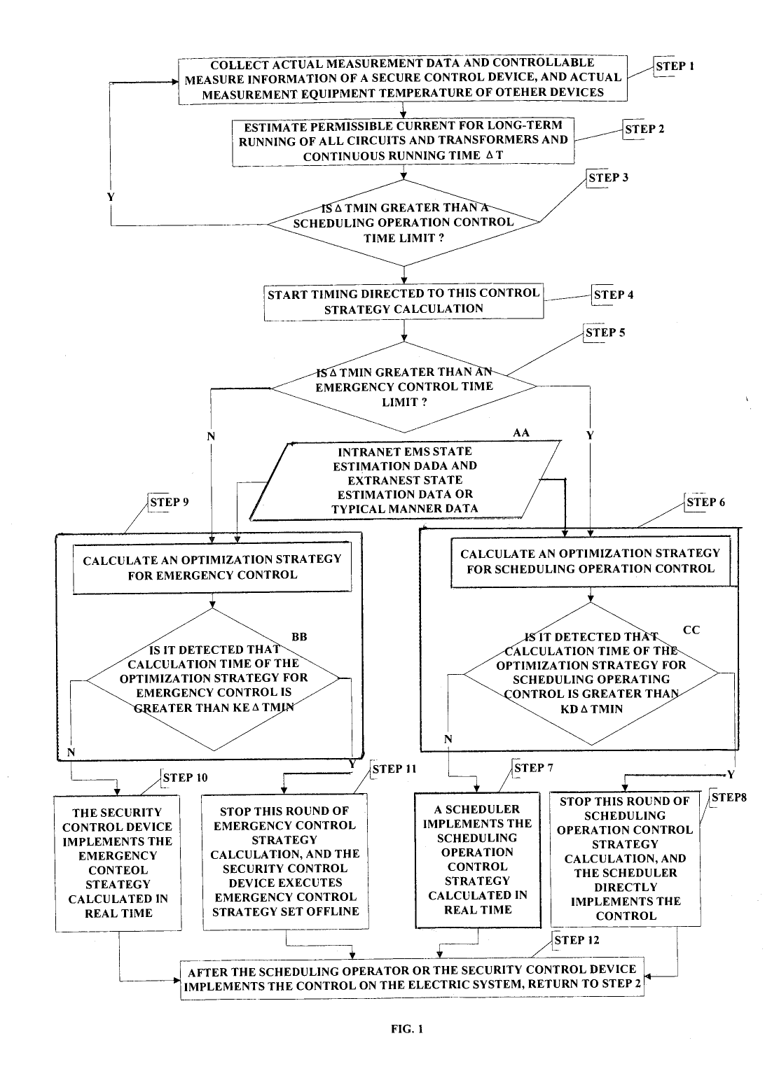

FIG. 1 is a flow chart of the method described by the present invention.

### DETAILED DESCRIPTION

The following describes method of the present invention in greater details in combination with FIG. 1.

In FIG. 1, step 1 describes a flow chart of cyclic collection of measured information, including equipment power flow information (including equipment current) acquired in real-time by SCD, information of controllable measures, and equipment temperature information acquired in real-time by equipment temperature detector, with equipment current and temperature information saved.

In FIG. 1, step 2 describes the method of estimation of equipment long-term allowable current Ir and continuous operation time Δt under present operating environment according to measured information. Details of this method are given below.

For equipment for which the temperature can be actually measured, real-time estimation of Ir and Δt is only carried out if the measured temperature rises and the ratio of measured current to preset rated current exceeds a set threshold. For such equipment that does not satisfy these two conditions, Ir is taken as its rated current and Δt is set to long-term. In collected equipment current and temperature history information (I(t), T(t)), take history data of two periods starting from the most recent measurement time point (earlier than this point). Assume that the first period provides data of m time points in chronological order, namely [(I_{1.i}(t_{1.i}), T_{1.i}(t_{1.i})), i=1, 2, . . . , m], and that the second period provides data of n time points in chronological order, namely [(I_{2.j}(t_{2.j}), T_{2.j}(t_{2.j})), j=1, 2, . . . , n]. Then, equipment Ir is estimated using formula (1), where

$$a = {\sum }_{i = 1}^{m - 1} [ {( \frac{{I}_{1 , i} + {I}_{1 , i + 1}}{2} )}^{2} ( {t}_{1 , i + 1} - {t}_{1 , i} ) ] , \\ b = {\sum }_{j = 1}^{n - 1} [ {( \frac{{I}_{2 , j} + {I}_{2 , j + 1}}{2} )}^{2} ( {t}_{2 , j + 1} - {t}_{2 , j} ) ]$$

and k₁ is a correction factor.

$${I}_{r} = {k}_{1} \sqrt{\frac{a ( {T}_{2. n} - {T}_{2.1} ) - b ( {T}_{1. m} - {T}_{1.1} )}{( {t}_{2. n} - {t}_{2.1} ) ( {T}_{1. m} - {T}_{1.1} ) - ( {t}_{1. m} - {t}_{1.1} ) ( {T}_{2. n} - {T}_{2.1} )}} \qquad ( 1 )$$

According to equipment current I(tᵣₜ) and corresponding temperature T(tᵣₜ) of equipment acquired in real-time at the most recent time point, in history information (I(t), T(t)) of current and temperature of this equipment, starting from the most recent measurement time point backward (to earlier time), find measurement time points of T(t) less than T(tᵣₜ) in sequence. If the period between two time points (tᵣₜ−t) exceeds a set value and the equipment current difference between them is less than a set value, then formula (2) is used to estimate Δt of this equipment. In this formula, Tcr is the highest permissible operation temperature of the equipment under present environment, and k₂ is a correction factor.

$$Δ t = {k}_{2} \frac{ {t}_{rt} - t}{T ( {t}_{rt} ) - T ( t )} ( {T}_{cr} - T ( {t}_{rt} ) ) \qquad ( 2 )$$

For equipment for which temperature is not actually measured, if the function (Δt=f(I)) of equipment Δt to current in present operating environment is available, equipment Iᵣ is taken as the value of current corresponding to dispatching operation control time limit t_{d} (e.g. 15 min) timed by a coefficient less than 1. If only equipment Δt to current correspondence table (Δtₖ, Iₖ) under present operating environment is available, curve fitting will be carried out according to such time to current correspondence points, to obtain function (Δt=f(I)) of Δt to current of this equipment, and then equipment Iᵣ is taken as the value of current corresponding to t_{d} timed by a coefficient less than 1.

If the present measured current of equipment exceeds Iᵣ, in equipment current history information collected, take history data of a period starting from the most recent measurement time point (to earlier time). Assume that this period contains data of m time points in chronological order, namely [Iᵢ(tᵢ), i=1, 2, . . . , m], it is required that current at the first time point of this period I₁(t₁) is less than or equal to Iᵣ, and that current at the second time point of this period I₂(t₂) exceeds Ir. Formula (3) is used to estimate Δt of this equipment. If the present measured current of the equipment is less than or equal to Iᵣ, Δt of this equipment is set to long-term.

$$Δ t = f ( {I}_{m} ) [ 1 - {\sum }_{i = 1}^{m - 1} \frac{{t}_{i + 1} - {t}_{i}}{f ( \frac{{I}_{i + 1} + {I}_{i}}{2} )} ] \qquad ( 3 )$$

In FIG. 1, step 3 describes determination whether control is required to eliminate equipment overload for the electric power system according to equipment Δt estimated in real-time in step 2. If minimum value Δtₘᵢₙ of all equipment Δt exceeds t_{d}, then neither calculation of control strategy nor control measures will be performed, and the flow will go back to step 2; otherwise go to step 4.

In FIG. 1, step 4 describes start of counting of time for the control strategy calculation flow, so that to be in time to terminate the control strategy calculation if strategy search process takes too long.

In FIG. 1, step 5 describes determination of adoption of dispatching operation control or emergency control by comparison of Δtₘᵢₙ with emergency control time limit tₑ (e.g. 5 min). If Δtₘᵢₙ exceeds tₑ, go to step 6 for calculation and implementation of dispatching operation control optimization strategy; otherwise go to step 9 for calculation and implementation of emergent control optimization strategy.

In FIG. 1, step 6 describes dispatching operation control strategy optimization calculation flow for electric power system in equipment overload alarm state. This flow includes 3 sub-steps: External Network static equivalence, Internal Network and External Network operation profile data integration, and optimal dispatching operation control strategy calculation. This step also cyclically detects whether total time of these 3 sub-steps is taking too long, and if total time exceeds k_{d}Δtₘᵢₙ (k_{d} is less than 1), this flow will be terminated, and then go to step 8; otherwise step 7 will be entered after dispatching operation control optimized strategy is obtained.

Sub-step 1: External Network static equivalence: to be carried out based on External Network state estimation data or typical operation mode data, and according to the criterion that electric distance between External Network side buses of tie-line between External Network and Internal Network (grid under dispatching management) shall exceed the set value.

Sub-step 2: Internal Network and External Network operation profile data integration: based on Internal Network state estimation data and External Network equivalence data, and according to real-time power flow data of equipment of Δt less than t_{d} (abbreviated as overload equipment in alarm state) and power flow data acquired in real-time by SCD.

Sub-step 3: optimal dispatching operation control strategy calculation: for the grid after equivalence, using the objective function aimed to minimize total control cost and comprehensive indexes of proportions of load control quantity in different regions, taking into consideration discreteness and cost of dispatching operation control measures, and under the restraint of electric power system power flow, and based on mixed integer nonlinear programming algorithm, centralized decision-making optimization and successive approximation control strategy are adopted to calculate real-time optimal dispatching operation control strategy for equipment overload in alarm state. Its objective function is formula (4). In this formula, term 1 is the cost of generator active power adjustment, P_{Gi} and P′_{Gi} are active power output before and after adjustment of generator i in this round of control strategy optimization calculation, Cᵢ is unit active power adjustment cost of generator i, and G is total number of generators that can be adjusted. Term 2 is the load control cost: if load j is shed, Lⱼ is 1; otherwise it is 0; C_{Lj} is load shedding cost of load j, and L is total number of loads that can be controlled. Term 3 reflects decentralized load control requirements: N is total number of regions for which power outage effect index is examined, P_{Lj} is active power of the load at the most recent time point after occurrence of this overload event and before taking the control measures, Zₖ is the k^{th} examined region, x is a set coefficient (greater than 1), and k₃ is the factor of converting power outage effect to control cost.

$$min \{ {\sum }_{i = 1}^{G} ( \vert {P}_{Gi} - {P}_{Gi}^{′} \vert {C}_{i} ) + {\sum }_{j = 1}^{L} ( {L}_{j} {C}_{Lj} ) + {k}_{3} {\sum }_{k = 1}^{N} {[ \frac{{\sum }_{j ∈ {Z}_{k}} ( {L}_{j} {P}_{Lj} )}{{\sum }_{j ∈ {Z}_{k}} {P}_{Lj}} ]}^{x} \} \qquad ( 4 )$$

Corresponding restraint conditions are given in formula (5), including power flow equation restraint (including bus voltage restraint), equipment overload restraint, and dispatching operation control measures space restraint to be selected. In this formula, Iᵣⱼ is long-term allowable current of equipment j estimated in step 2, Iⱼ₀ is current in equipment j at the most recent time point before this round of control strategy calculation, λ_{d} is set dispatching operation control successive approximation coefficient, and M_{d} is number of equipment for which Δr estimated in real-time in sub-step 2 is less than k′_{d}t_{d} (k′_{d} is greater than 1). This optimization calculation of dispatching operation control strategy for overload event has considered the restraint that generator active power output adjustment direction cannot be reversed and that after load control, such load cannot be restored.

$$\{ \begin{matrix}Power flow equation \\ {I}_{j} < ( 1 + {λ}_{d} \frac{{I}_{rj}}{{I}_{j 0}} ) {I}_{rj} , j = 1 , 2 , … , {M}_{d} \\ Space of control measures to be selected \\ ( \begin{matrix}is set of controllable measures in the \\ scope of dispatching management .\end{matrix} )\end{matrix} \qquad ( 5 )$$

In FIG. 1, step 7 describes control implementation by dispatching operator using the dispatching operation control strategy obtained in step 6.

In FIG. 1, step 8 describes electric power system control by dispatching operator according to control procedure and operation experience.

In FIG. 1, step 9 describes optimal emergency control strategy calculation flow for electric power system in equipment overload emergent state. This flow includes 3 sub-steps: External Network static equivalence, Internal Network and External Network operation profile data integration, and optimal emergency control strategy calculation. This step also cyclically detects whether total time of these 3 sub-steps is taking too long, and if exceeds kₑΔtₘᵢₙ (kₑ is less than 1), this flow will be terminated, and then go to step 11; otherwise step 10 will be entered after optimized emergency control strategy is obtained.

Sub-step 1: External Network static equivalence: to be carried out based on External Network state estimation data or typical operation mode data, and according to the criterion that electric distance between External Network side buses of tie-line between External Network and Internal Network (grid under dispatching management) shall exceed the set value.

Sub-step 2: Internal Network and External Network operation profile data integration: based on Internal Network state estimation data and External Network equivalence data, and according to real-time power flow data of equipment of Δt less than tₑ (abbreviated as overload equipment in emergent state) and power flow data acquired in real-time by SCD.

Sub-step 3: optimal emergency control strategy calculation: for the grid after equivalence, using the objective function aimed to minimize total control cost and comprehensive indexes of proportions of load control quantity in different regions, taking into consideration of discreteness and cost of emergency control measures, and under the restraint of electric power system power flow, and based on mixed integer nonlinear programming algorithm, centralized decision-making optimization and successive approximation control strategy are adopted to calculate optimal emergency control strategy for equipment overload in emergent state. Its objective function is formula (6). In this formula, term 1 is generator emergency control cost, comprising two parts: power adjustment cost and shutdown cost. If generator i is tripped, then Gᵢ is 1; otherwise it is 0. C_{Gi} is shutdown cost of generator i. Gₑ is total number of generators controlled by the SCD. Term 2 is the load control cost: Lₑ is total number of loads controlled by the SCD. Term 3 reflects decentralized load control requirements: y is a set coefficient (greater than 1 and less than or equal to x). Meanings of other variables are the same as described earlier.

$$min \{ {\sum }_{i = 1}^{{G}_{e}} [ {G}_{i} ( {P}_{Gi} {C}_{i} + {C}_{Gi} ) ] + {\sum }_{j = 1}^{{L}_{e}} ( {L}_{j} {C}_{Lj} ) + {k}_{3} {\sum }_{k = 1}^{N} {[ \frac{{\sum }_{j ∈ {Z}_{k}} ( {L}_{j} {P}_{Lj} )}{{\sum }_{j ∈ {Z}_{k}} {P}_{Lj}} ]}^{y} \} \qquad ( 6 )$$

Corresponding restraint conditions are given in formula (7), including power flow equation restraint (including bus voltage restraint), equipment overload restraint, and emergency control measures space restraint to be selected. In this formula, Iᵣⱼ is long-term allowable current of equipment j estimated in step 2, Iⱼ₀ is current in equipment j at the most recent time point before this round of control strategy calculation, λₑ is set emergency control successive approximation coefficient, and Mₑ is number of equipment for which Δt estimated in real-time in sub-step 2 is less than k′ₑtₑ (k′ₑ is greater than 1).

$$\{ \begin{matrix}Power flow equation \\ {I}_{j} < ( 1 + {λ}_{e} \frac{{I}_{rj}}{{I}_{j 0}} ) {I}_{rj} , j = 1 , 2 , … , {M}_{e} \\ Space of control measures to be selected \\ ( is set of controllable measures by SCD . )\end{matrix} \qquad ( 7 )$$

In FIG. 1, step 10 describes control of the electric power system by SCD using the emergency control strategy obtained in step 9.

In FIG. 1, step 11 describes control of the electric power system by SCD using offline emergency control strategy.

In FIG. 1, step 12 describes returning to step 2 after control of the electric power system by dispatching operator or SCD, for repeated real-time judgment and decision-making of equipment operation state.

The claims are as follows:

1. An equipment overload successive approximation adaptive control method based on centralized real-time decision-making, comprising:
1) Based on equipment current acquired in real-time by a security control device (SCD), and temperature information acquired in real-time by an equipment temperature monitoring device, estimating in real-time a long-term allowable current and a continuous operation time of equipment under present operating environment;
2) If a minimum value of the continuous operation time of all equipment is greater than a set dispatching operation control time limit, neither control strategy calculation nor control of the electric power system will be performed; If this minimum value is less than or equal to the dispatching operation control time limit but greater than an emergency control time limit, go to step 3) for optimal dispatching operation control strategy calculation and implementation; If this minimum value is less than or equal to the emergency control time limit, go to step 4) for optimal emergency control strategy calculation and implementation;
3) Based on a grid beyond the dispatching management (abbreviated as External Network) state estimation data or typical operation mode data, carry out static equivalence of the External Network according to the criterion that electric distance between External Network side buses of tie-line between External Network and Internal Network (grid under dispatching management) shall exceed the set value, and then based on Internal Network state estimation data and External Network equivalence data, carry out the operation profile data integration according to real-time power flow data of equipment of continuous operation time less than or equal to dispatching operation control time limit (such equipment is referred to as overload equipment in alarm state) and power flow data acquired in real-time by SCD, and later for the grid after equivalence, using the objective function aimed to minimize total control cost and comprehensive indexes of proportions of load control quantity in different regions, taking into consideration discreteness and cost of dispatching operation control measures, and under the restraint of electric system power flow, and based on mixed integer nonlinear programming algorithm, centralized decision-making optimization and successive approximation control strategy are adopted for calculation of real-time optimal dispatching operation control strategy for equipment overload in alarm state, which will be implemented by dispatching operator; after implementation of control measures, return to step 1);
4) Based on External Network state estimation data or typical operation mode data, carry out static equivalence of the External Network according to the criterion that electric distance between External Network side buses of tie-line between External Network and Internal Network (grid under dispatching management) shall exceed the set value, next based on Internal Network state estimation data and External Network equivalence data, carry out the operation profile data integration according to real-time power flow data of equipment of continuous operation time less than or equal to emergency control time limit (such equipment is referred to as overload equipment in emergent state) and power flow data acquired in real-time by SCD, and later for the grid after equivalence, using the objective function aimed to minimize total control cost and comprehensive indexes of proportions of load control quantity in different regions, taking into consideration discreteness and cost of emergency control measures, aand under the restraint of electric system power flow, and based on mixed integer nonlinear programming algorithm, centralized decision-making optimization and successive approximation control strategy are adopted for calculation of real-time optimal emergency control strategy for equipment overload in emergent state, which will be implemented by SCD; after implementation of control measures, return to step 1).

2. The equipment overload successive approximation adaptive control method based on centralized real-time decision-making according to claim 1, wherein step 1), namely estimation of long-term allowable current and continuous operation time of equipment under present operating environment according to measured information, differentiates two situations:
For equipment for which the temperature can be actually measured, real-time estimation of Ir and Δt is only carried out if the measured temperature rises and the ratio of measured current to preset rated current exceeds a set threshold. For such equipment that does not satisfy these two conditions, Ir is taken as its rated current and Δt is set to long-term;
In collected equipment current and temperature history information (I(t), T(t)), take history data of two periods starting from the most recent measurement time point (earlier than this point). Assume that the first period provides data of m time points in chronological order, namely [(I_{1.i}(t_{1.i}), T_{1.i}(t_{1.i})), i=1, 2, . . . , m], and that the second period provides data of n time points in chronological order, namely [(I_{2.j}(t_{2.j}), T_{2.j}(t_{2.j}), j=1, 2, . . . , n]. Then, equipment Ir is estimated using formula (1), where
$$a = {\sum }_{i = 1}^{m - 1} [ {( \frac{{I}_{1. i} + {I}_{1. i + 1}}{2} )}^{2} ( {t}_{1. i + 1} - {t}_{1. i} ) ] , \\ b = {\sum }_{j = 1}^{n - 1} [ {( \frac{{I}_{2. j} + {I}_{2. j + 1}}{2} )}^{2} ( {t}_{2. j + 1} - {t}_{2. j} ) ]$$
and k₁ is a correction factor.
$${I}_{r} = {k}_{1} \sqrt{\frac{a ( {T}_{2. n} - {T}_{2.1} ) - b ( {T}_{1. m} - {T}_{1.1} )}{( {t}_{2. n} - {t}_{2.1} ) ( {T}_{1. m} - {T}_{1.1} ) - ( {t}_{1. m} - {t}_{1.1} ) ( {T}_{2. n} - {T}_{2.1} )}} \qquad ( 1 )$$
According to equipment current I(tᵣₜ) and corresponding temperature T(tᵣₜ) of equipment acquired in real-time at the most recent time point, in history information (I(t), T(t)) of current and temperature of this equipment, starting from the most recent measurement time point backward (to earlier time), find measurement time points of T(t) less than T(tᵣₜ) in sequence. If the period between two time points (tᵣₜ−t) exceeds a set value and the equipment current difference between them is less than a set value, then formula (2) is used to estimate Δt of this equipment. In this formula, Tcr is the highest permissible operation temperature of the equipment under present environment, and k₂ is a correction factor;
$$Δ t = {k}_{2} \frac{ {t}_{rt} - t}{T ( {t}_{rt} ) - T ( t )} ( {T}_{cr} - T ( {t}_{rt} ) ) \qquad ( 2 )$$
For equipment for which temperature is not actually measured, if the function (Δt=f(I)) of equipment Δt to current in present operating environment is available, equipment Iᵣ is taken as the value of current corresponding to dispatching operation control time limit t_{d} (e.g. 15 min) timed by a coefficient less than 1. If only equipment Δt to current correspondence table (Δtₖ, Iₖ) under present operating environment is available, curve fitting will be carried out according to such time to current correspondence points, to obtain function (Δt=f(I)) of Δt to current of this equipment, and then equipment Iᵣ is taken as the value of current corresponding to t_{d} timed by a coefficient less than 1;
If the present measured current of equipment exceeds Iᵣ, in equipment current history information collected, take history data of a period starting from the most recent measurement time point (to earlier time). Assume that this period contains data of m time points in chronological order, namely [Iᵢ(tᵢ), i=1, 2, . . . , m], it is required that current at the first time point of this period I₁(t₁) is less than or equal to Iᵣ, and that current at the second time point of this period I₂(t₂) exceeds Ir. Formula (3) is used to estimate Δt of this equipment. If the present measured current of the equipment is less than or equal to Iᵣ, Δt of this equipment is set to long-term.
$$Δ t = f ( {I}_{m} ) [ 1 - {\sum }_{i = 1}^{m - 1} \frac{{t}_{i + 1} - {t}_{i}}{f ( \frac{{I}_{i + 1} + {I}_{i}}{2} )} ] \qquad ( 3 )$$

3. The equipment overload successive approximation adaptive control method based on centralized real-time decision-making according to claim 1, wherein in step 2), according to equipment Δt estimated in real-time, determine whether control measures to eliminate equipment overload is required, and if positive, what control shall be adopted; In particular, if minimum value Δtₘᵢₙ of all equipment Δt exceeds t_{d}, neither control strategy calculation nor control will be carried out. If Δtₘᵢₙ is less than or equal to t_{d} but greater than emergency control time limit tₑ, then dispatching operation control strategy calculation and implementation will be carried out. If Δtₘᵢₙ is less than or equal to tₑ, then emergency control strategy calculation and implementation will be carried out.

4. The equipment overload successive approximation adaptive control method based on centralized real-time decision-making according to claim 1, wherein in step 3), based on mixed integer nonlinear programming algorithm, calculation of real-time dispatching operation control strategy for equipment overload in alarm state is carried out, and its objective function is formula (4); In this formula, term 1 is the cost of generator active power adjustment, P_{Gi} and P′_{Gi} are active power output before and after adjustment of generator i in this round of control strategy optimization calculation, Cᵢ is unit active power adjustment cost of generator i, and G is total number of generators that can be adjusted; Term 2 is the load control cost: if load j is shed, Lⱼ is 1; otherwise it is 0; C_{Lj} is load shedding cost of load j, and L is total number of loads that can be controlled. Term 3 reflects decentralized load control requirements: N is total number of regions for which power outage effect index is examined, P_{Lj} is active power of the load at the most recent time point after occurrence of this overload event and before taking the control measures, Zₖ is the k^{th} examined region, x is a set coefficient (greater than 1), and k₃ is the factor of converting power outage effect to control cost;
$$min \{ {\sum }_{i = 1}^{G} ( \vert {P}_{Gi} - {P}_{Gi}^{′} \vert {C}_{i} ) + {\sum }_{j = 1}^{L} ( {L}_{j} {C}_{Lj} ) + {k}_{3} {\sum }_{k = 1}^{N} {[ \frac{{\sum }_{j ∈ {Z}_{k}} ( {L}_{j} {P}_{Lj} )}{{\sum }_{j ∈ {Z}_{k}} {P}_{Lj}} ]}^{x} \} \qquad ( 4 )$$
Corresponding restraint conditions are given in formula (5), including power flow equation restraint (including bus voltage restraint), equipment overload restraint, and dispatching operation control measures space restraint to be selected. In this formula, Iᵣⱼ is long-term allowable current of equipment j estimated in step 2, Iⱼ₀ is current in equipment j at the most recent time point before this round of control strategy calculation, λ_{d} is set dispatching operation control successive approximation coefficient, and M_{d} is number of equipment for which Δr estimated in real-time in sub-step 2 is less than k′_{d}t_{d} (k′_{d} is greater than 1); This optimization calculation of dispatching operation control strategy for overload event has considered the restraint that generator active power output adjustment direction cannot be reversed and that after load control, such load cannot be restored.
$$\{ \begin{matrix}Power flow equation \\ {I}_{j} \leq ( 1 + {λ}_{d} \frac{{I}_{rj}}{{I}_{j 0}} ) {I}_{rj} , j = 1 , 2 , … , {M}_{d} \\ \begin{matrix}Space of control measures to be selected \\ ( \begin{matrix}is set of controllable measures in \\ the scope of dispatching management\end{matrix} )\end{matrix}\end{matrix} \qquad ( 5 )$$

5. The equipment overload successive approximation adaptive control method based on centralized real-time decision-making according to claim 1, wherein in step 3), if time of calculation of dispatching operation control strategy has exceeded k_{d}Δtₘᵢₙ (k_{d} is less than 1), this calculation will be terminated, and dispatching operator will control the electric power system according to control procedure and operation experience.

6. The equipment overload successive approximation adaptive control method based on centralized real-time decision-making according to claim 1, wherein in step 4), based on mixed integer nonlinear programming algorithm, calculation of emergency control strategy for equipment overload in emergent state will be carried out, and its objective function is formula (6);
In this formula, term 1 is generator emergency control cost, comprising two parts: power adjustment cost and shutdown cost. If generator i is tripped, then Gᵢ is 1; otherwise it is 0. C_{Gi} is shutdown cost of generator i. Gₑ is total number of generators controlled by the SCD. Term 2 is the load control cost: Lₑ is total number of loads controlled by the SCD. Term 3 reflects decentralized load control requirements: y is a set coefficient (greater than 1 and less than or equal to x);
$$min \{ {\sum }_{i = 1}^{{G}_{e}} [ {G}_{i} ( {P}_{Gi} {C}_{i} + {C}_{Gi} ) ] + {\sum }_{j = 1}^{{L}_{e}} ( {L}_{j} {C}_{Lj} ) + {k}_{3} {\sum }_{k = 1}^{N} {[ \frac{{\sum }_{j ∈ {Z}_{k}} ( {L}_{j} {P}_{Lj} )}{{\sum }_{j ∈ {Z}_{k}} {P}_{Lj}} ]}^{y} \} \qquad ( 6 )$$
Corresponding restraint conditions are given in formula (7), including power flow equation restraint (including bus voltage restraint), equipment overload restraint, and emergency control measures space restraint to be selected. In this formula, Iᵣⱼ is long-term allowable current of equipment j estimated in step 2, Iⱼ₀ is current in equipment j at the most recent time point before this round of control strategy calculation, λₑ is set emergency control successive approximation coefficient, and Mₑ is number of equipment for which Δt estimated in real-time in sub-step 2 is less than k′ₑtₑ (k′ₑ is greater than 1).
$$\{ \begin{matrix}Power flow equation \\ {I}_{j} \leq ( 1 + {λ}_{e} \frac{{I}_{rj}}{{I}_{j 0}} ) {I}_{rj} , j = 1 , 2 , … , {M}_{e} \\ \begin{matrix}Space of control measures to be selected \\ ( is set of controllable measures by SCD . )\end{matrix}\end{matrix} \qquad ( 7 )$$

7. The equipment overload successive approximation adaptive control method based on centralized real-time decision-making according to claim 1, wherein in step 4), if time of calculation of emergency control strategy has exceeded kₑΔtₘᵢₙ (kₑ is less than 1), this calculation will be terminated, and SCD will control the electric system using offline emergency control strategy.

8. The equipment overload successive approximation adaptive control method based on centralized real-time decision-making according to claim 1, wherein step 3) and step 4) have considered measures of DC adjustment, reactive power control, and equipment switch-on/off etc. the control cost of which can almost be neglected in search of optimal control strategy, by setting the candidate control measures space.
